(19) United States
(12) Patent Application Publication
(10) Pub. No.: US 2006/0259902 A1
(43) Pub. Date: Nov. 16, 2006

(54) Embedded system self-updating method and device

(76) Inventor: Fan-Sheng Lin, Taipei City (TW)

Correspondence Address: HARNESS, DICKEY & PIERCE, P.L.C., P.O. BOX 8910, RESTON, VA, 20195, US

(21) Appl. No.: 11/175,264

(22) Filed: Jul. 7, 2005

(30) Foreign Application Priority Data
May 13, 2005 (TW) 94115692

(51) Int. Cl. G06F 9/44

(52) U.S. Cl. 717/168

(57) ABSTRACT

An embedded system self-updating method and device. When the embedded system connecting to the computer is utilized to perform the firmware update, the update interface chip communicates directly with the computer and obtains from it the firmware-update-data, which is then written into the memory according to its respective destination address, thus achieving the update of the firmware.

### BACKGROUND OF INVENTION

1. Field of the Invention

The invention relates to a method and a device used for updating the embedded system firmware, and in particular to an embedded system in which a newly added update interface chip is used to enable the embedded system to have self-updating capability, so as to update the firmware.

2. Related Art

With the advent of the intelligent household appliance, the research and development of the embedded system for use in such household electronic appliances has become ever more important. Nowadays, the applications of the various embedded systems in household electrical appliances are enormous, such as the microwave oven, the refrigerator, the washing machine, the TV set and the like.

Originally, these were designed to provide only some basic functions. However, due to the rapid progress of science and technology, these household appliances are now developed to provide full-fledged 3C (computer, communication, and consumer) functions. Thus the designs of such products have become much more refined and versatile.

In practice, the embedded system is actually a miniature computer system having the standard equipment of the CPU (central processing unit), the main memory, and the related storage device. In general, such an embedded system does not need to have the full-fledged functions of the ordinary computer. Thus, it is rather designed to achieve the features of compact size, power conservation, and low cost, and is mainly utilized to handle specific events in real time. As such, compared with the operation system of the main computer, the instruction set in the CPU of the embedded system is smaller, the sizes of the firmware and the application programs are also smaller, so the memory and storage space required are not too large, thus achieving the above-mentioned objectives.

The PDA (personal data assistant) is a typical embedded system, with its basic framework as shown in FIG. 1. In recent years the development and the introduction of new products has been conducted at an increasing rate to satisfy the demands of the market and the aspirations of consumers, so it happens quite often that just when a new product has just been introduced onto the market, new features and the specifications of more advanced versions are announced. For the newly announced product, usually the software/hardware integration may have not been fully tested. However, it is rushed to the market on or before schedule to gain an extra competitive edge. Thus it happens quite often that there may still exist a few problems in the product.

If it is merely a hardware problem, then the product is sent back to the manufacturer for replacement; otherwise, if it is a software problem, then as shown in FIG. 1, the user has only to download the update program from the related service website to the computer 20. Next, s/he loads the firmware-update-data 190 into the personal data assistant 10 through the interface chip 110 by means of a wired (e.g. RS-232 or USB) and/or wireless means. Then, utilizing the embedded system processor 130 to update the firmware 160, the system parameters 150 and the document file are stored in the ROM (Read Only Memory) 120, the EEPROM (Electrically Erasable Programmable Read Only Memory) 140, and the RAM (Random Access Memory) 180 respectively.

However, in the aforementioned firmware update method and device of the prior art, there still exist quite a few problems. Firstly, since the firmware 160 is the OS (Operation System) of the embedded system, the firmware having incomplete and inadequate functions is not capable of operating fully the update program. Thus, even with the upgraded firmware update file provided by the manufacturer, the firmware update may still not be able to be performed. Secondly, sometimes the power management program in the firmware 160 is out of order, so that the embedded system 10 cannot be powered on and the firmware update cannot be performed.

Thirdly, another reason that the embedded system is not able to be operated is that the Boot Loader 170 stored in the ROM 120 is damaged due to human operation errors, thus results from voltage instability or short circuit. Under these circumstances, even if repairs may be done by making use of firmware update, since the embedded system cannot be powered on, the firmware 160 cannot be loaded in by the CPU to perform the update required. In this condition, the embedded system must be sent back to the manufacturer to replace it with ROM 120 that can function normally.

Sometimes the system update is not merely directed to the firmware 160 of the ROM 120, the system parameter 150 stored in the EEPROM 140, or the Boot Loader 170 of the ROM 120. Rather, it may involve updating two or all three of them simultaneously. Due to the fact that the design of the program developer may not be perfect, or the user may not understand the operation instructions thoroughly before executing the update, version mismatching among the three items may occur. I.e., the version of the firmware 160 may not be matched to that of the system parameter 150, or the version of the Boot Loader 170 may not be matched to that of the firmware 160.

Therefore, the user lacks the benefit of smooth and efficient system operation by making use of the firmware update, and is subject to inconveniences. Thus, the benefit of the firmware update functions provided by the manufacturer cannot be realized. From the above discussion it is evident that the firmware update utilized presently has its problems and shortcomings, and in particular human error in its related operation processes may result in very serious consequences.

### SUMMARY OF THE INVENTION

In view of the above-mentioned problems and shortcomings of the prior art, the object of the invention is to provide an embedded system self-updating method and device, wherein an additional update interface chip is provided in the embedded system, which is isolated with the embedded system processor and is used to obtain the firmware-update-data and the power required directly from the computer through the USB (universal serial bus), and write the update data directly into the respective memory or the update interface memory.

In order to achieve the above-mentioned objective, the invention provides an update interface chip and two system configurations utilizing such chips in realizing the software update. In the system configuration of the invention, in addition to the update interface chip, three additional buses are provided connecting respectively to the RAM (Random Access Memory), ROM (Read Only Memory) and the EEPROM (Electrically Erasable Programmable Read Only Memory), so that the downloaded firmware-update-data can be written directly into the memory according to its destination address for firmware update without having to go through the processing of the embedded system processor. Or, the firmware, system parameter, the application program and the document files which originally are distributed in the various embedded system memories and may be put together and merged into an update interface memory so that the number of the bus in the system can remain unchanged, and thus the power required for the firmware update can be obtained through the USB (universal serial bus) without having to use the power of the embedded system itself, so as to achieve the objective of firmware update. As such, the system design can be simplified and the production cost can be reduced. In addition, the update interface memory may be simulated and realized as the MSC(Mass Storage Class) disk by making use of the update interface chip. Thus, the firmware-update-data can be written into the memory directly by means of such a mechanism.

The firmware update can be realized through the aforementioned configuration in the following two manners.

Firstly, the firmware-update-data is written directly into the memory blocks of RAM, ROM and EEPROM through three newly added buses via the update interface chip to update the firmware, the system parameters, and the document files respectively. Similarly, when the firmware, the system parameters, the application program and the document files are put together and merged into an update interface memory, the data update may be achieved through the update interface chip according to the destination address of the update data.

Secondly, in an alternative manner, the update data may be packaged into an update-data-image-file, and the update interface memory can be simulated and realized as the MSC disk by making use of the update interface chip. Thus the user has only to put the update-data-image-file into the simulated MSC disk, and the update interface chip is then used to receive the update-data-image-file from the computer. Then, the data is written into the memory to update the firmware, the system parameters, and the application program and description documents according to their respective destinations, thus realizing the data update.

Further scope of the applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given below, which is for illustration only and thus is not limitative of the invention, and wherein:

FIG. 1 is a schematic diagram of the system structure of the embedded system of the prior art;

FIG. 2 is a schematic diagram of the system structure of the invention according to the first embodiment;

FIG. 3 is a flowchart of the invention method according to the first embodiment;

FIG. 4 is a schematic diagram of the system structure of the invention according to the second embodiment;

FIG. 5 is a schematic diagram of the system structure of the invention according to the third embodiment;

FIG. 6 is a schematic diagram of the contents of the updating-data image file of the invention;

FIG. 7 is a schematic diagram of the data in the simulated MSC(Mass Storage Class) disk of the invention; and

FIG. 8 is a flowchart of the invention method according to the second embodiment of the invention.

### DETAILED DESCRIPTION OF THE INVENTION

The purpose, construction, features, and functions of the invention can be appreciated and understood more thoroughly through the following detailed description with reference to the attached drawings. The invention provides an embedded system self-updating method and device. In the following description, numerous specific details are intended to provide a through understanding of the invention. However, for people familiar with the art, the invention can be implemented without such specific details. Furthermore, alternative elements or methods may be utilized to realize the invention. In certain specific circumstances, well known methods, procedures, elements, and circuits are not described in detail, so as not to unnecessarily obscure the essence of the invention.

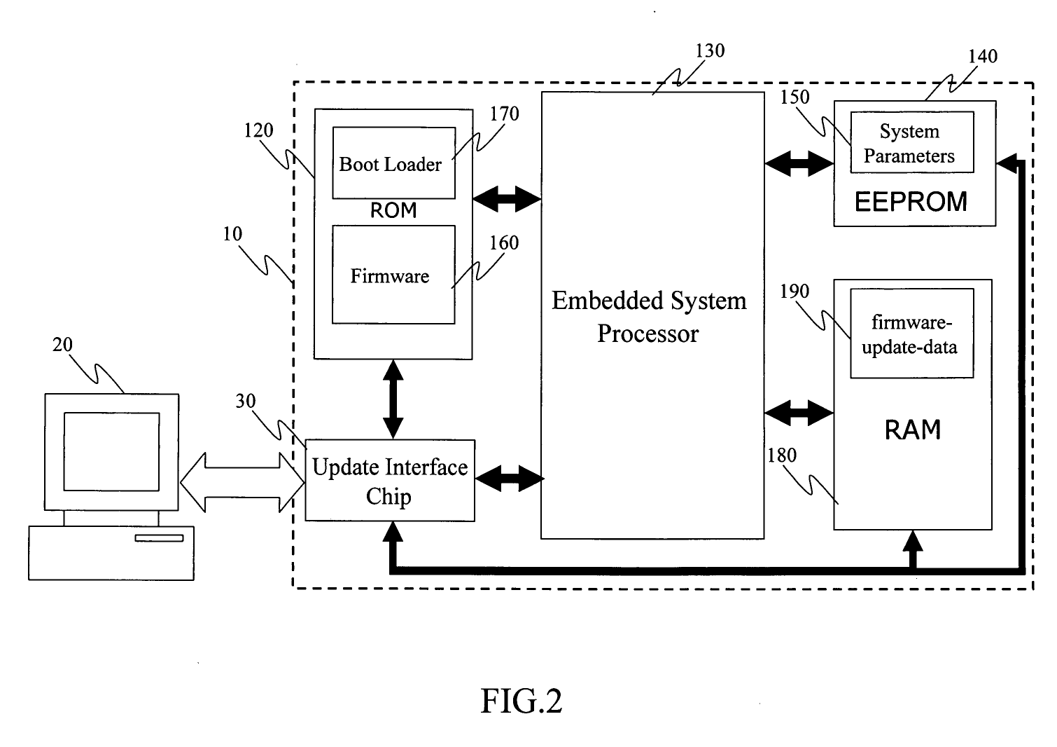

Refer to FIG. 2 for a schematic diagram of the system structure of the invention according to the first embodiment of the invention, which is an improvement of the embedded system of the prior art. As shown in FIG. 2, the unique feature of the invention is that in the embedded system 10 of the prior art, the update of the firmware 160 must be performed by the embedded system processor 130. However, if any of the system parameters 150, the firmware 160, or the Boot Loader 170 is out of order, then the system-boot can not be performed, and the subsequent firmware update and the related repairs cannot proceed. In view of the shortcomings of the prior art, the invention provides an additional update interface chip 30 in the embedded system 10, which is connected directly and independently to a computer 20 and can be operational without necessitating system activation by the embedded system processor 130. In addition, the update interface chip 30 is connected to the computer 20 through the USB(Universal Serial Bus), which is not only used to transmit data, but is also used to obtain the power required from the computer. Thus, it is utilized to enable the update interface chip 30 to write the firmware-update-data 190 into the related memory. Alternatively, the IEEE 1394 interface may be used to replace the USB to achieve similar results.

In order that the firmware data update can be performed without requiring the processing of the embedded system processor 130, three additional buses are provided and connected to the EEPROM 140, ROM 120, and RAM 180, which are used to store the system parameters 150, the firmware 160, the Boot Loader 170, and the firmware-update-data 190 respectively.

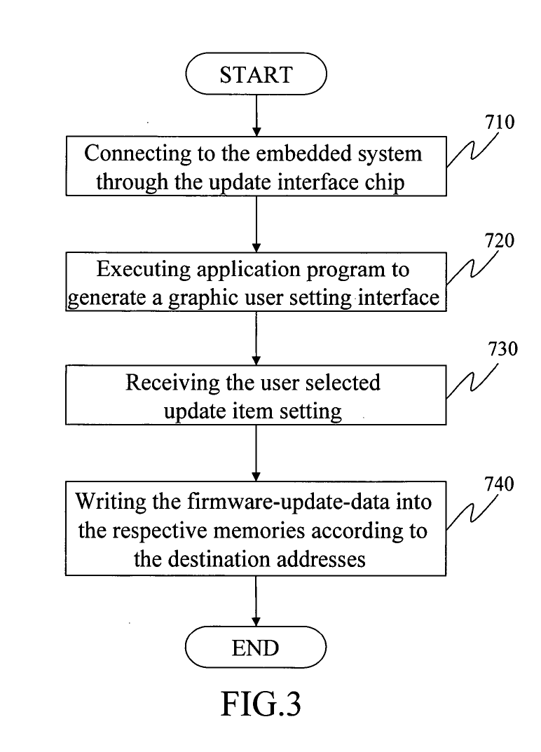

Refer to FIG. 3 for a flowchart of the invention method according to the first embodiment of the invention. Firstly, connect the update interface chip 30 to the computer 20 through the USB interface (step 710). Next, execute the application program 630 to generate a graphic user setting interface on the computer screen (step 720); the application program 630 is utilized to analyze the versions of the firmware in the embedded system 10 and display the menu items so that the user may select the portions to be updated in the embedded system 10. Then, transmit the firmware-update-data 190 to the update interface chip 30 according to the setting input by the user through the computer screen (step 730). And finally, write the firmware-update-data 190 respectively to the EEPROM 140, ROM 120, and RAM 180 according to their respective destination addresses (step 740).

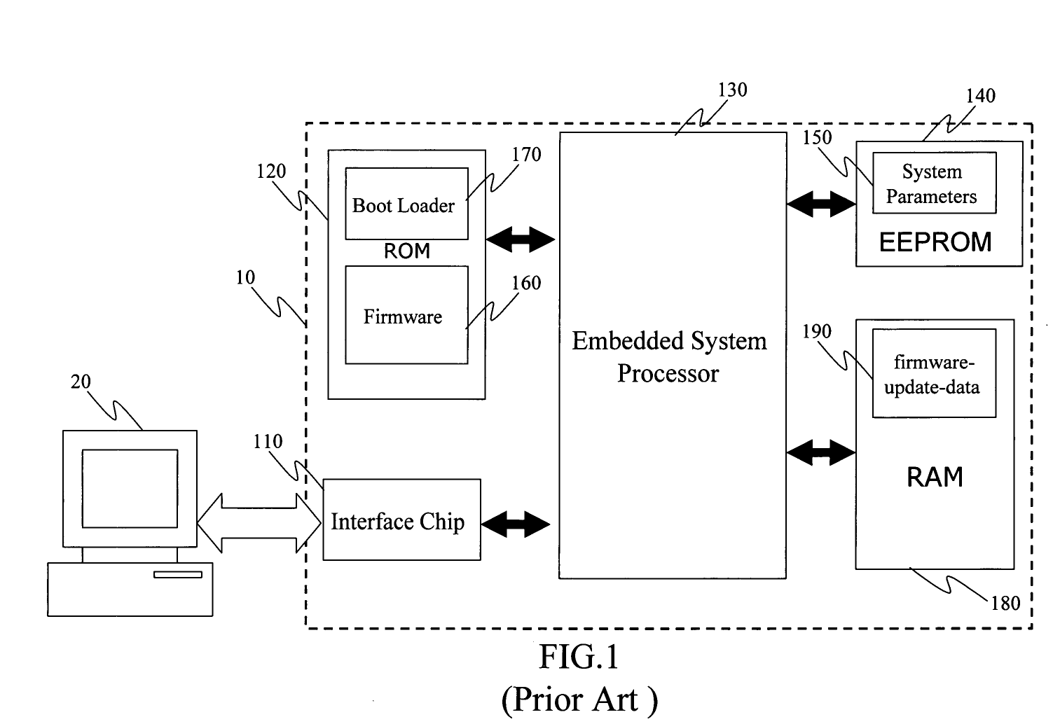

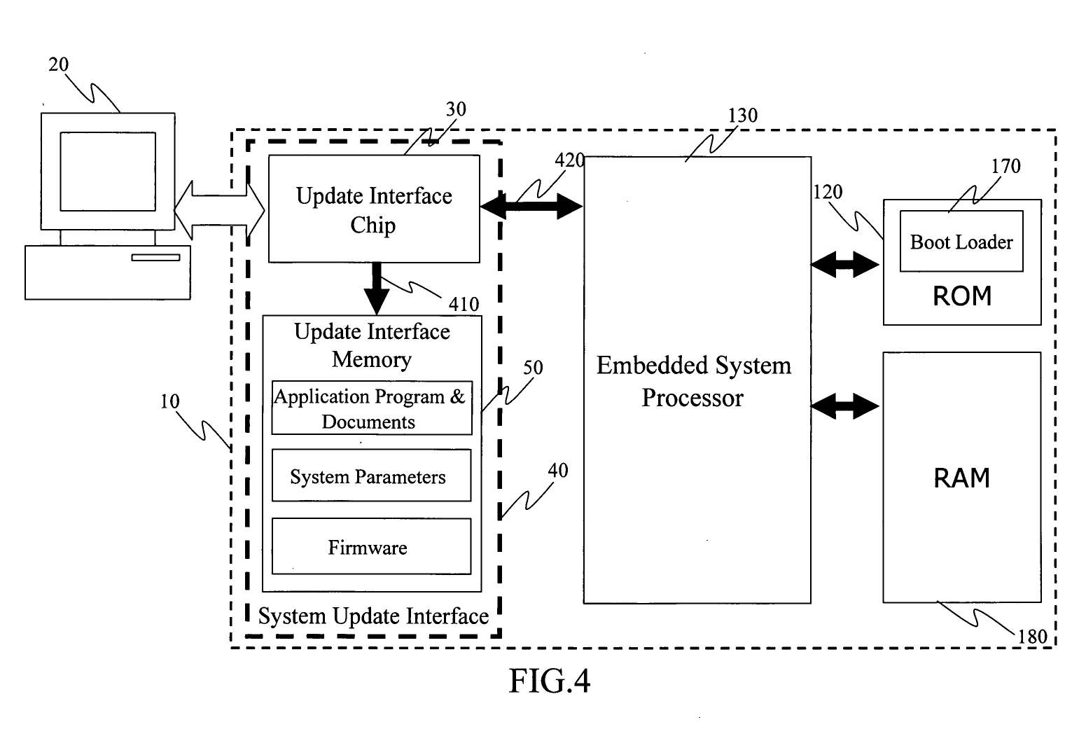

However, in the aforementioned system structure, the addition of the extra buses increases the complexity in the design of circuit wiring and thus increases the production cost, so that the original system structure requires proper adjustment. Refer to FIG. 4 for a schematic diagram of the invention according to the second embodiment of the invention. As shown in FIG. 4, the original system structure is rearranged with the formation of a system update interface 40 in the embedded system 10. Compared with the embedded system of the prior art, as shown in FIG. 1, in the embedded system 10 of the invention, the number of buses remains at 4. However, the firmware 160, the system parameters 150, the application program 630, and the documents 640 are all gathered together and put into the newly created update interface memory 50, which is composed mainly of the ROM that does not constantly require power to maintain its data, such as the EEPROM, the Serial Interface ROM, or the Parallel Interface ROM. As such, for the formation of the system update interface 40, there is no need to add the additional buses in the embedded system 10. Moreover, under the control and management of the update interface chip 30, there is no need for the embedded system processor 130 to act as an intermediate to process and transmit data, nor is the power of the embedded system itself required. Instead, the update interface chip 30 is used to obtain the power required to operate the system update interface 40 through the USB, so as to realize the data update independently.

Upon completion of the firmware update, the embedded system 10 is utilized to perform the system-boot. Firstly, the Boot Loader 170 in the ROM 120 is loaded in. Then, the firmware 160 in the update interface memory 50 is loaded in by the update interface chip 30 through the first bus 410 according to the settings of the Boot Loader 170, which is used in cooperation with the system parameters 150 to complete the related setting and the system-boot.

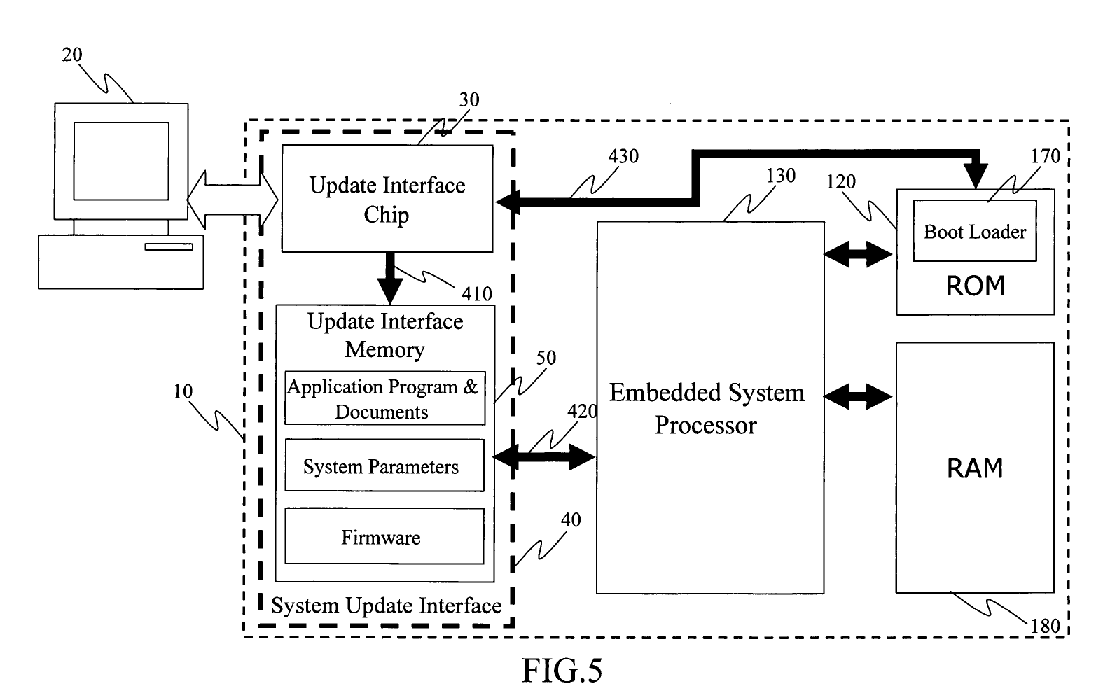

In an alternative arrangement, as shown in FIG. 5, a second bus 420 that was originally connected between the update interface chip 30 and the embedded system processor 130, as shown in FIG. 4, can be rearranged and instead connected between the embedded system processor 130 and update interface memory 50. As such, the embedded system processor 130 can be used to directly access the updated firmware 160 and its system parameters 150 in the update interface memory 50 to proceed with the system-boot, without having to go through the data-update operation of the update interface chip 30.

In general, the Boot Loader 170 stored in the ROM 120 does not need to be updated, so it is not included in the updating-data image file 60, thus reducing the errors in the data update process. However, if an error does occur during the data update process, then it has to be repaired. Therefore, in the system structure of the embedded system 10 of the invention, a third bus 430 is added and connected between the update interface chip 30 and the ROM 120 so that upon receiving the update data from the computer 20, the correct Boot Loader 170 is transmitted by the update interface chip 30 through the third bus and written directly into the ROM 120. Thus, the Boot Loader 170 can be repaired and updated even when the embedded system 10 cannot perform the system-boot.

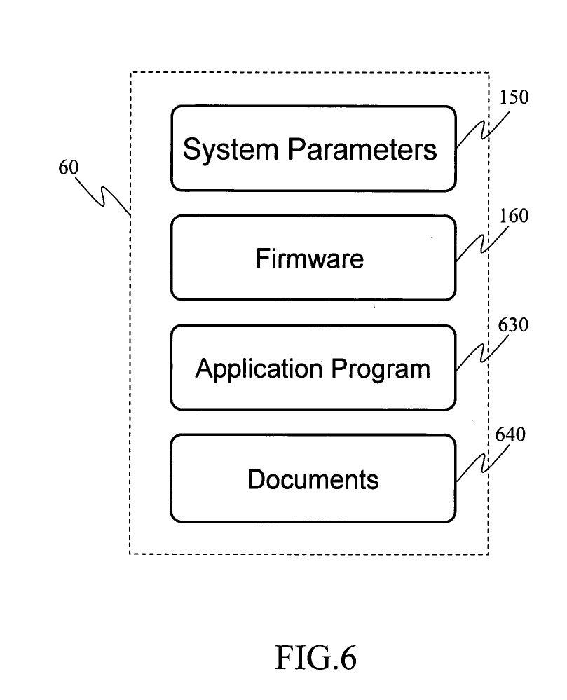

Next, refer to FIG. 6 for a schematic diagram of the contents of the updating-data image file of the invention. As shown in FIG. 6, the data of the firmware 160, system parameters 150, application program 630 and the documents 640 that are to be updated during data update are packaged into the updating-data image file 60 according to their destination addresses. Upon executing data update through the update interface chip 30, the update data is written into various locations in the memory of the embedded system simultaneously according the set pattern of the updating-data image file 60.

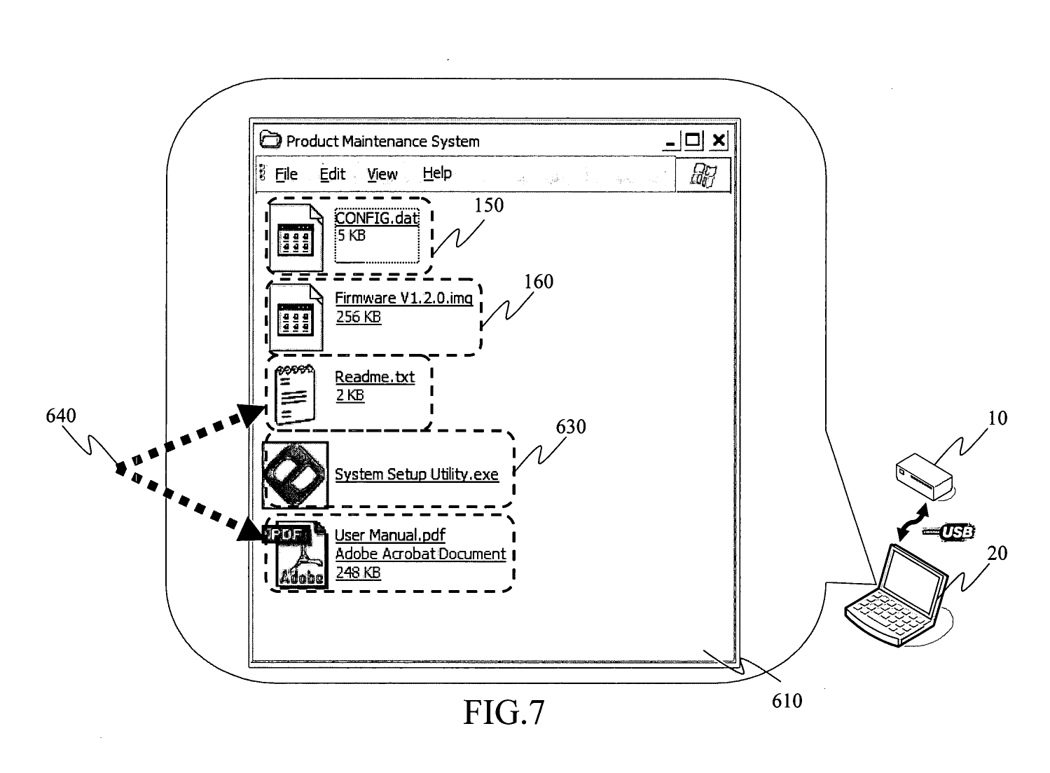

In addition to being connected to the computer to receive the firmware-update-data 190, which is written into the memory of the update interface memory 50 according to its respective destination address, the update interface chip 30 can also simulate the MSC(Mass Storage Class) disk 610. When the update interface chip 30 is connected to the computer 20 as shown in FIG. 7, the update interface memory 50 can simulate the MSC disk 610 through the update interface chip 30, so that the firmware-update-data 190 is displayed on the screen of the computer 20 as the ordinary data, such as: the system parameters 150 with the file name CONFIG.dat; the updated firmware 160 with the file name Firmware V1.2.0.img; the System Setup Utility.exe, which is the utility program for setting the firmware parameters and is updated in cooperation with the update of the firmware 160 so that it can proceed with the setting of the firmware parameters; and the documents 640 corresponding to the firmware version.

As mentioned above, when the user operates the computer 20 to simulate the update interface memory 50 as the MSC disk 610, it is as if conducting ordinary data writing onto the disk. In writing in the data, the data is displayed on the screen. Upon finishing writing the data, the screen indicating the firmware-update-data 190 is displayed as the data on the MSC disk 610. Through simulating the MSC disk 610, the visual effect of the data update process can be obtained. Besides, the MSC disk 610 belongs to a standard specification, which can be operated without having an attached driving program. In addition, it is provided with the support of a plurality of operation platforms, thus having very good portability.

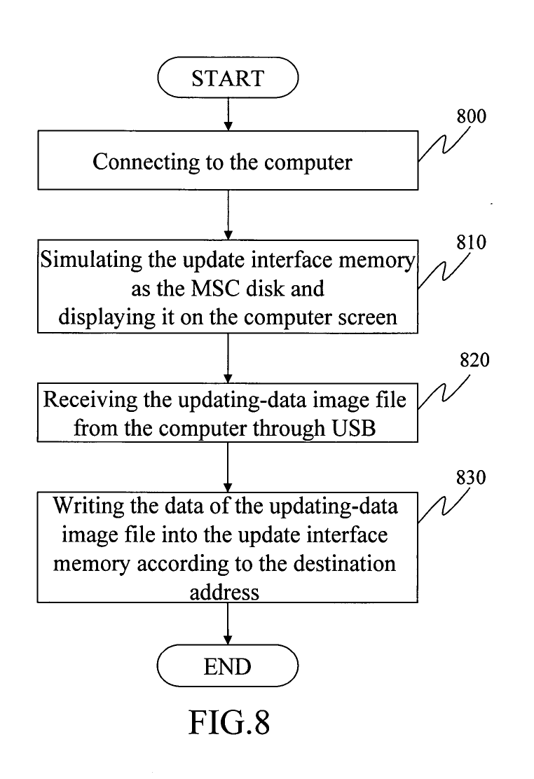

Finally, refer to FIG. 8 for a flowchart of the invention method according to the second embodiment of the invention. Firstly, connect the update interface chip 30 to the computer 20 upon inserting the embedded system 10 into connection port of the computer 20 through the USB (step 800). Next, display on the screen of the computer 20 the frame image of simulating the update interface memory 50 as the MSC disk 610 (step 810). Then, the update interface chip 30 receives the updating-data image file 60 transmitted from the computer 20 (step 820). And finally, write the system parameters 150, the firmware 160, the application program 630 and the documents 640 of the updating-data image file 60 into the corresponding destination addresses of the update interface memory 50 according to the settings of the various update data (step 830), thus making user operation more convenient. Therefore, all the user has to do is to copy the firmware-update-data 190 or the data of the update data image file 60 onto the MSC disk 610, and does not have to be concerned about writing which file onto which position of the memory. Furthermore, in the data write-in/update process, the progress of data update at the present stage can be known more fully through the dynamic display of the data written on the screen, thus reducing the occurrences of mistakenly terminating the data update process prematurely.

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An embedded system self-updating device, connected to an embedded system processor through a first bus, comprising:
an update interface chip, used to receive firmware-update-data transmitted from a computer, and perform respectively the writing of firmware and system parameter into the memory;
an update interface memory, used to store the firmware, and store said system parameter required in running the firmware; and
a second bus, used to connect to said update interface chip and said update interface memory.

2. The device of claim 1, wherein said update interface memory is a serial interface read-only-memory (ROM).

3. The device of claim 1, wherein said update interface memory is a parallel interface read-only-memory (ROM).

4. The device of claim 1, wherein said update interface memory further comprising a plurality of documents and an application program which can be executed on said computer.

5. The device of claim 4, wherein said application program is used to update said firmware.

6. The device of claim 4, wherein said application program is used to set said system parameters.

7. The device of claim 1, wherein said update interface chip is used to receive said firmware-update-data from said computer through a USB(Universal Serial Bus) interface and obtain the power required.

8. The device of claim 1, wherein said update interface chip is used to receive said firmware-update-data from said computer through an IEEE 1394 interface and obtain the power required.

9. The device of claim 1, wherein said update interface memory can be simulated as the MSC(Mass Storage Class) disk through said update interface chip.

10. The device of claim 1, wherein said firmware-update-data is an updating-data image file comprising a firmware, a system parameter, an application program and a plurality of documents.

11. The device of claim 10, wherein when updating by said updating-data image file, said update interface chip is used to write said firmware-update-data into said update interface memory according to the destination address of said firmware-update-data.

12. A self-updating embedded system, including an embedded system processor, a random access memory, and a read only memory having a Boot Loader, further comprising:
a system update interface, used to self-update and repair a firmware of said embedded system, further comprising the following units:
an update interface chip, used to receive a plurality of firmware-update-data transmitted from a computer, and perform respectively the writing of the firmware and a plurality of system parameters into the memory;
an update interface memory, used to store said firmware of the embedded system, and store said system parameters; and
a first bus, used to connect between said update interface chip and said update interface memory, so as to enable said update interface chip to access said firmware and said system parameters stored in said update interface memory; and
a second bus, connected between said embedded system processor and said system update interface.

13. The system of claim 12, wherein said update interface memory is a serial interface read-only-memory (ROM).

14. The system of claim 12, wherein said update interface memory is a parallel interface read-only-memory (ROM).

15. The system of claim 12, wherein if said second bus is connected between said embedded system processor and said update interface chip, then during the system-boot said firmware is loaded in through said update interface chip.

16. The system of claim 12, wherein if said second bus is connected between said embedded system processor and said update interface memory, then said firmware is loaded in directly to processing the system-boot.

17. The system of claim 12, wherein said update interface memory further comprising a plurality of documents and an application program which can be executed on said computer.

18. The system of claim 17, wherein said application program is used to update said firmware.

19. The system of claim 17, wherein said application program is used to set said system parameters.

20. The system of claim 12, wherein said system update interface is used to receive said firmware-update-data from said computer through an USB and obtain the power required.

21. The system of claim 12, wherein said update interface memory can be simulated as a MSC disk through said update interface chip.

22. The system of claim 12, wherein said system update interface is used to receive said firmware-update-data from said computer through an IEEE 1394 interface and obtain the power required.

23. The system of claim 12, wherein said firmware-update-data is a data of the updating-data image file comprising a firmware, a system parameter, an application program and a plurality of documents.

24. The system of claim 23, wherein when updating by said updating-data image file, said update interface chip is used to write said firmware-update-data into said update interface memory according to the destination address of said respective firmware-update-data.

25. A self-updating method of an embedded system, said embedded system including an update interface chip, an update interface memory and a bus connected in between, said method comprising the following steps:
establishing a connection between said update interface chip and a computer;
simulating on said computer said connected update interface memory as a MSC disk;
putting the updating-data image file comprising a plurality of firmware-update-data from said computer into said MSC disk; and
writing said respective firmware-update-data into said update interface memory by said update interface chip according to the destination address of said respective firmware-update-data.

26. The method of claim 25, wherein said update interface chip is used to connect to and obtain power from said computer through an USB interface.

27. The method of claim 25, wherein said update interface chip is used to connect to and obtain power from said IEEE 1394 interface.

28. The method of claim 25, wherein the data in said update interface memory comprises a firmware, a system parameter, an application program and a plurality of documents.

29. The method of claim 25, wherein when the data of said updating-data image file is transmitted into said update interface memory, then an animation of windows indicating the data of written-in file is displayed on the screen of said computer.
